(19) United States
(12) Patent Application Publication
(10) Pub. No.: US 2026/0148518 A1
(43) Pub. Date: May 28, 2026

(54) TRAINING METHOD FOR A NEURAL NETWORK MODEL FOR IMAGE PROCESSING ELECTRONIC DEVICE AND MEDIUM

(71) Applicant: BEIJING BAIDU NETCOM SCIENCE TECHNOLOGY CO., LTD., BEIJING (CN)

(72) Inventors: Yizhan ZHAO, BEIJING (CN); Huaifei XING, BEIJING (CN)

(73) Assignee: BEIJING BAIDU NETCOM SCIENCE TECHNOLOGY CO., LTD., BEIJING (CN)

(21) Appl. No.: 18/991,930

(22) Filed: Dec. 23, 2024

(30) Foreign Application Priority Data
Sep. 9, 2024 (CN) 202411261683.6

(51) Int. Cl. G06V 10/28; G06V 10/25; G06V 10/26; G06V 10/77; G06V 10/774; G06V 10/82

(52) U.S. Cl. CPC G06V 10/28; G06V 10/25; G06V 10/26; G06V 10/7715; G06V 10/774; G06V 10/82

(57) ABSTRACT

A training method for a neural network model for image processing is provided. The present disclosure relates to the technical field of artificial intelligence, and in particular to the technical field of image recognition. The neural network model includes a first sub-model and a second sub-model, and a training method for the first sub-model includes: obtaining a first sample image and labeling a ground truth coordinate value of a region of interest in the first sample image; inputting the first sample image into the first sub-model to obtain a first output; and adjusting parameters of the first sub-model; a training method for the second sub-model includes: obtaining a second sample image and labeling a ground truth threshold; inputting the second sample image into the first sub-model and obtaining a second output of the first sub-model; inputting the second output into the second sub-model and obtaining a predicted threshold output by the second sub-model; and adjusting parameters of the second sub-model based on the ground truth threshold and the predicted threshold.

### TECHNICAL FIELD

The present disclosure relates to the field of artificial intelligence technology, and in particular to the field of image recognition technology, and specifically to a training method for a neural network model for image processing, a method for image recognition, an apparatus, an electronic device, a computer-readable storage medium, and a computer program product.

### BACKGROUND

Artificial intelligence is the discipline of the study of making computers simulate certain thinking processes and intelligent behaviors of a human being (such as learning, reasoning, thinking, planning, etc.), and there are both hardware-level and software-level technologies. The artificial intelligence hardware technologies generally include technologies such as sensors, special artificial intelligence chips, cloud computing, distributed storage, big data processing, etc.; The artificial intelligence software technologies mainly include computer vision technology, speech recognition technology, natural language processing technology and machine learning/deep learning, big data processing technology, knowledge graph technology and other major technological directions.

In catering stores, warehousing, logistics and other fields, densely stacked items such as tableware and goods need to be counted quickly and accurately. Such counting usually relies on manual operation, which is not only time-consuming and laborious but also susceptible to the influence of human factors, resulting in inaccurate counting result. With the development of image processing technology, automatic counting methods which are based on images have gradually become a research hotspot, and how to process images more effectively such that a fast and accurate counting can be achieved based on the processed images has become a problem to be solved.

The methods described in this section are not necessarily methods that have been previously conceived or employed. Unless otherwise indicated, it should not be assumed that any method described in this section is considered to be the prior art only due to its inclusion in this section. Similarly, the problems mentioned in this section should not be assumed to be recognized in any prior art unless otherwise indicated.

### SUMMARY

The present disclosure provides a training method for a neural network model for image processing, a method for image recognition, an apparatus, an electronic device, a computer-readable storage medium, and a computer program product.

According to an aspect of the present disclosure, there is provided a training method for a neural network model for image processing, wherein the neural network model comprises a first sub-model and a second sub-model, and wherein the training method comprises a training method for the first sub-model and a training method for the second sub-model, and wherein the training method for the first sub-model comprises: obtaining a first sample image comprising first items to be counted and labeling a ground truth coordinate value of a region of interest in the first sample image; inputting the first sample image into the first sub-model and obtaining a first output of the first sub-model, wherein the first output represents a predicted coordinate value of the region of interest in the first sample image; adjusting parameters of the first sub-model based on the ground truth coordinate value and the predicted coordinate value, and wherein the training method for the second sub-model comprises: in response to the completion of the training of the first sub-model, obtaining a second sample image comprising second items to be counted and labeling a ground truth threshold for binarizing the second sample image, wherein the outline of the second items to be counted in the second sample image, after being binarized based on the ground truth threshold, satisfies a clarity criterion; inputting the second sample image into the first sub-model and obtaining a second output of the first sub-model, wherein the second output represents a predicted coordinate value of the region of interest of the second sample image; inputting the second output into the second sub-model and obtaining a predicted threshold for binarizing the second sample image output by the second sub-model; calculating a loss value based on the ground truth threshold and the predicted threshold; and adjusting parameters of the second sub-model based on the loss value, wherein the second sample image, after being binarized based on the predicted threshold, can be used to identify and count the second items to be counted included therein.

According to another aspect of the present disclosure, there is provided a method for image recognition, comprising: obtaining a first image comprising items to be counted, wherein the items to be counted are stacked along a first direction in the first image; determining a threshold for binarizing the first image using a neural network model; binarizing the first image based on the threshold to obtain a second image; setting a first sliding window in the second image and making the first sliding window slide M times in the second image along a second direction, wherein the length of the first sliding window in the first direction is not less than the length of the second image in the first direction, and wherein the second direction is perpendicular to the first direction, and wherein M is an integer greater than 1; identifying the number Cntᵢ of the items to be counted included within the first sliding window in each slide, wherein i∈[1, M]; and determining, based on the number Cntᵢ corresponding to each slide of the first sliding window, the number of the items to be counted in the first image, wherein the neural network model is obtained by training according to the aforementioned training method for a neural network model for image processing.

According to another aspect of the present disclosure, there is provided a training apparatus for a neural network model for image processing, wherein the neural network model comprises a first sub-model and a second sub-model, and wherein the training apparatus comprises a training apparatus for the first sub-model and a training apparatus for the second sub-model, and wherein the training apparatus for the first sub-model comprises: a first obtaining module configured to obtain a first sample image comprising first items to be counted and label a ground truth coordinate value of a region of interest in the first sample image; a second obtaining module configured to input the first sample image into the first sub-model and obtain a first output of the first sub-model, wherein the first output represents a predicted coordinate value of the region of interest in the first sample image; a first adjustment module configured to adjust parameters of the first sub-model based on the ground truth coordinate value and the predicted coordinate value, and wherein the training apparatus for the second sub-model comprises: a third obtaining module configured to, in response to the completion of the training of the first sub-model, obtain a second sample image comprising second items to be counted and label a ground truth threshold for binarizing the second sample image, wherein the outline of the second items to be counted in the second sample image, after being binarized based on the ground truth threshold, satisfies a clarity criterion; a fourth obtaining module configured to input the second sample image into the first sub-model and obtain a second output of the first sub-model, wherein the second output represents a predicted coordinate value of the region of interest of the second sample image; a sixth obtaining module configured to input the second output into the second sub-model and obtain a predicted threshold for binarizing the second sample image output by the second sub-model; a calculation module configured to calculate a loss value based on the ground truth threshold and the predicted threshold; and a second adjustment module configured to adjust parameters of the second sub-model based on the loss value, wherein the second sample image, after being binarized based on the predicted threshold, can be used to identify and count the second items to be counted included therein.

According to another aspect of the present disclosure, there is provided an apparatus for image recognition, comprising: a seventh obtaining module configured to obtain a first image comprising items to be counted, wherein the items to be counted in the first image are stacked along a first direction; a second determination module configured to determine a threshold for binarizing the first image using a neural network model; an image processing module configured to binarize the first image based on the threshold to obtain a second image; a first sliding module configured to set a first sliding window in the second image and make the first sliding window slide M times in the second image along a second direction, wherein the length of the first sliding window in the first direction is not less than the length of the second image in the first direction, and wherein the second direction is perpendicular to the first direction, and wherein M is an integer greater than 1; a third determination module configured to identify the number Cntᵢ of the items to be counted included within the first sliding window in each slide, wherein i∈[1, M]; and a fourth determination module configured to determine, based on the number Cntᵢ corresponding to each slide of the first sliding window, the number of the items to be counted in the first image, wherein the neural network model is obtained by training according to the aforementioned training method for a neural network model for image processing.

According to another aspect of the present disclosure, there is provided an electronic device, comprising: at least one processor; and a memory communicatively connected to the at least one processor; wherein the memory stores instructions executable by the at least one processor, and the instructions are executed by the at least one processor to enable the at least one processor to perform any of the aforementioned methods.

According to another aspect of the present disclosure, there is provided a non-transient computer-readable storage medium storing computer instructions, wherein the computer instructions are used to enable the computer to perform any of the aforementioned methods.

According to another aspect of the present disclosure, there is provided a computer program product, including a computer program, wherein the computer program implements any of the aforementioned methods when executed by a processor.

According to one or more embodiments of the present disclosure, there is provided a training method for a neural network model for image processing, wherein the trained neural network model is used to predict a region of interest in an image and can predict a threshold for binarizing the image, the neural network model is utilized to determine the region of interest and the threshold for binarizing the image, the region of interest and the threshold can be dynamically adjusted and determined according to the actual image, and the image is binarized based on the dynamically predicted threshold to make the outline of the items to be counted in the processed image clearer, thereby improving the accuracy of counting when subsequently counting the items in the above processed image.

It should be understood that the content described in this section is not intended to identify key or important features of the embodiments of the present disclosure, nor is it intended to limit the scope of the present disclosure. Other features of the present disclosure will become readily understood from the following description.

### BRIEF DESCRIPTION OF THE DRAWINGS

The drawings exemplarily illustrate embodiments and constitute a part of the specification, and are used in conjunction with the textual description of the specification to explain the example implementations of the embodiments. The illustrated embodiments are for illustrative purposes only and do not limit the scope of the claims. Throughout the drawings, like reference numerals refer to similar but not necessarily identical elements.

FIG. 1 is a schematic diagram illustrating an example system in which various methods described herein can be implemented according to exemplary embodiments.

FIG. 2 illustrates a flowchart of a training method for a neural network model for image processing according to embodiments of the present disclosure;

FIG. 3 illustrates an architectural diagram of a first sub-model according to embodiments of the present disclosure;

FIG. 4 illustrates an architectural diagram of a second sub-model according to embodiments of the present disclosure;

FIG. 5 illustrates a flowchart of a method for image recognition according to embodiments of the present disclosure;

FIG. 6 illustrates a schematic diagram of image processing utilizing a neural network model according to embodiments of the present disclosure;

FIG. 7 illustrates a structural block diagram of a training apparatus for a neural network model for image processing according to embodiments of the present disclosure;

FIG. 8 illustrates a structural block diagram of an apparatus for image recognition according to embodiments of the present disclosure; and

FIG. 9 illustrates a structural block diagram of an exemplary electronic device that can be used to implement embodiments of the present disclosure.

### EMBODIMENTS

The exemplary embodiments of the present disclosure are described below in conjunction with the accompanying drawings, including various details of the embodiments of the present disclosure to facilitate understanding, and they should be considered as example only. Therefore, one of ordinary skill in the art will recognize that various changes and modifications may be made to the embodiments described herein without departing from the scope of the present disclosure. Similarly, descriptions of well-known functions and structures are omitted in the following description for the purpose of clarity and conciseness.

In the present disclosure, unless otherwise specified, the terms “first”, “second” and the like are used to describe various elements and are not intended to limit the positional relationship, timing relationship, or importance relationship of these elements, and such terms are only used to distinguish one element from another. In some examples, the first element and the second element may refer to the same instance of the element, while in some cases they may also refer to different instances based on the description of the context.

The terminology used in the description of the various examples in this disclosure is for the purpose of describing particular examples only and is not intended to be limiting. Unless the context clearly indicates otherwise, if the number of elements is not specifically defined, the element may be one or more. In addition, the terms “and/or” used in the present disclosure encompass any one of the listed items and all possible combinations thereof.

In related art, a detection/segmentation model may be utilized to detect/segment items to be counted, and then the number of items is obtained by counting the result of the detection/segmentation. However, this counting scheme is applicable to a counting scenario in which the cross-sectional shape of the items is regular and the boundary is clear and regular, for example, the counting of items such as bamboo sticks and steel bars. In a scenario where the cross-sectional shape of the items is irregular and the items are stacked densely, the counting accuracy of the above counting scheme will be seriously degraded due to the inability to accurately determine the boundary of the items. In some related art, the counting of items can be performed based on a scheme of traditional image processing methods, specifically de-noising the image first, binarizing the image, then searching for the items to be counted through operations such as morphological erosion and dilation, searching for connected domains and the like, and finally counting the number of the items. However, this scheme is applicable to a scenario with relatively simple background and fixed threshold for binarizing the image. However, the actual scenario is complex and changeable, the binarization using a fixed threshold will not be able to adapt to the changeable scenario, therefore the scheme with fixed threshold lacks flexibility and has poor robustness.

To solve the above problem, the present disclosure provides a training method for a neural network model for image processing, wherein the trained neural network model is used to predict a region of interest in an image and can predict a threshold for binarizing the image, the neural network model is utilized to determine the region of interest and the threshold for binarizing the image, the region of interest and the threshold can be dynamically adjusted and determined according to the actual image, and the image is binarized based on the dynamically predicted threshold to make the outline of the items to be counted in the processed image clearer, thereby improving the accuracy of counting when subsequently counting the items in the above processed image.

The embodiments of the present disclosure will be described in detail below with reference to the accompanying drawings.

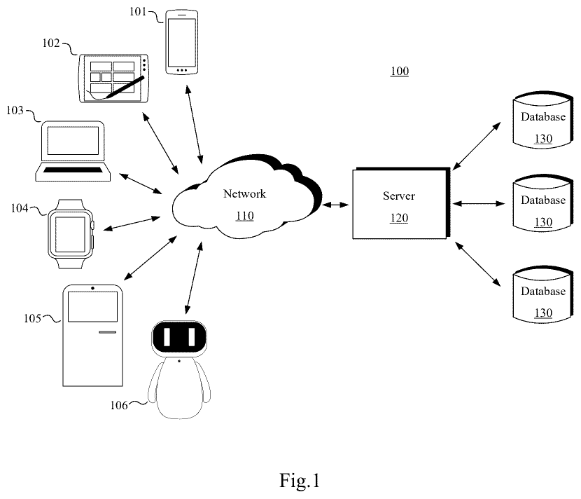

FIG. 1 illustrates a schematic diagram of an exemplary system 100 in which various methods and apparatuses described herein may be implemented in accordance with embodiments of the present disclosure. Referring to FIG. 1, the system 100 includes one or more client devices 101, 102, 103, 104, 105, and 106, a server 120, and one or more communication networks 110 that couple one or more client devices to the server 120. The client devices 101, 102, 103, 104, 105, and 106 may be configured to execute one or more applications.

In embodiments of the present disclosure, the server 120 may run one or more services or software applications that enable execution of a training method for a neural network model for image processing or a method for image recognition.

In some embodiments, the server 120 may also provide other services or software applications, which may include non-virtual environments and virtual environments. In some embodiments, these services may be provided as web-based services or cloud services, such as to the user of the client devices 101, 102, 103, 104, 105, and/or 106 under a Software as a Service (SaaS) model.

In the configuration shown in FIG. 1, the server 120 may include one or more components that implement functions performed by the server 120. These components may include software components, hardware components, or a combination thereof that are executable by one or more processors. A user operating the client devices 101, 102, 103, 104, 105, and/or 106 may sequentially utilize one or more client applications to interact with the server 120 to utilize the services provided by these components. It should be understood that a variety of different system configurations are possible, which may be different from the system 100. Therefore, FIG. 1 is an example of a system for implementing the various methods described herein and is not intended to be limiting.

The user may use the client devices 101, 102, 103, 104, 105, and/or 106 to execute the training method for a neural network model for image processing, the method for image recognition. The client devices may provide an interface that enables the user of the client devices to interact with the client devices. The client devices may also output information to the user via the interface. Although FIG. 1 depicts only six client devices, those skilled in the art will be able to understand that the present disclosure may support any number of client devices.

The client devices 101, 102, 103, 104, 105, and/or 106 may include various types of computer devices, such as portable handheld devices, general-purpose computers, such as personal computers and laptop computers, workstation computers, wearable devices, smart screen devices, self-service terminal devices, service robots, gaming systems, thin clients, various messaging devices, sensors, or other sensing devices, and the like. These computer devices may run various types and versions of software applications and operating systems, such as Microsoft Windows, Apple IOS, Unix-like operating systems, Linux or Linux-like operating systems (e.g., Google Chrome OS); or include various mobile operating systems, such as Microsoft Windows Mobile OS, iOS, Windows Phone, Android. The portable handhold devices may include cellular telephones, smart phones, tablet computers, personal digital assistants (PDA), and the like. The wearable devices may include head-mounted displays, such as smart glasses, and other devices. The gaming systems may include various handhold gaming devices, Internet-enabled gaming devices, and the like. The client devices can perform various different applications, such as various applications related to the Internet, communication applications (e.g., e-mail applications), Short Message Service (SMS) applications, and may use various communication protocols.

The network 110 may be any type of network well known to those skilled in the art, which may support data communication using any of a variety of available protocols (including but not limited to TCP/IP, SNA, IPX, etc.). By way of example only, one or more networks 110 may be a local area network (LAN), an Ethernet-based network, a token ring, a wide area network (WAN), an Internet, a virtual network, a virtual private network (VPN), an intranet, an external network, a blockchain network, a public switched telephone network (PSTN), an infrared network, a wireless network (for example, Bluetooth, WIFI), and/or any combination of these and/or other networks.

The server 120 may include one or more general-purpose computers, a dedicated server computer (e.g., a PC (personal computer) server, a UNIX server, a mid-end server), a blade server, a mainframe computer, a server cluster, or any other suitable arrangement and/or combination. The server 120 may include one or more virtual machines running a virtual operating system, or other computing architectures involving virtualization (e.g., one or more flexible pools of a logical storage device that may be virtualized to maintain virtual storage devices of a server). In various embodiments, the server 120 may run one or more services or software applications that provide the functions described below.

The computing unit in the server 120 may run one or more operating systems including any of the operating systems described above and any commercially available server operating system. The server 120 may also run any of a variety of additional server applications and/or intermediate layer applications, including a HTTP server, an FTP server, a CGI server, a JAVA server, a database server, etc.

In some implementations, the server 120 may include one or more applications to analyze and merge data feeds and/or event updates received from the user of the client devices 101, 102, 103, 104, 105, and/or 106. The server 130 may also include one or more applications to display the data feeds and/or the ground truth-time events via one or more display devices of the client devices 101, 102, 103, 104, 105, and/or 106.

In some embodiments, the server 120 may be a server of a distributed system, or a server incorporating a block chain. The server 120 may also be a cloud server, or an intelligent cloud computing server or an intelligent cloud host with an artificial intelligence technology. The cloud server is a host product in a cloud computing service system to overcome the defects of management difficulty and weak service expandability exiting in a traditional physical host and virtual private server (VPS) service.

The system 100 may also include one or more databases 130. In certain embodiments, these databases may be used to store data and other information. For example, one or more of the databases 130 may be used to store information such as audio files and video files. The databases 130 may reside in various locations. For example, the database used by the server 120 may be local to the server 120, or may be remote to the server 120 and may communicate with the server 120 via a network-based or dedicated connection. The databases 130 may be of different types. In some embodiments, the database used by the server 120 may be, for example, a relational database. One or more of these databases may store, update, and retrieve data to and from the database in response to a command.

In some embodiments, one or more of the databases 130 may also be used by an application to store application data. The databases used by the application may be different types of databases, such as a key-value repository, an object repository, or a conventional repository supported by a file system.

The system 100 of FIG. 1 may be configured and operated in various ways to enable application of various methods and apparatuses described according to the present disclosure.

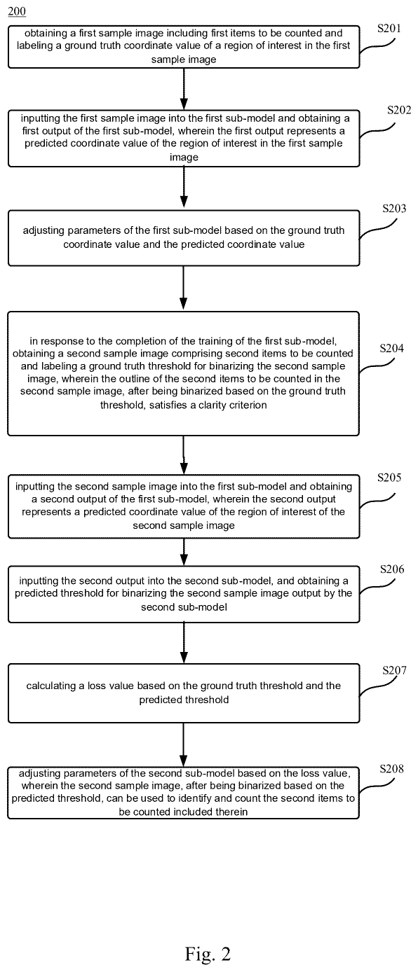

FIG. 2 illustrates a flowchart of a training method for a neural network model for image processing according to embodiments of the present disclosure, and the neural network model comprises a first sub-model and a second sub-model;

The training method 200 comprises a training method for the first sub-model and a training method for the second sub-model, as shown in FIG. 2, and the training method for the first sub-model comprises:
step S201, obtaining a first sample image including first items to be counted and labeling a ground truth coordinate value of a region of interest in the first sample image;
step S202, inputting the first sample image into the first sub-model and obtaining a first output of the first sub-model, wherein the first output represents a predicted coordinate value of the region of interest in the first sample image;
step S203, adjusting parameters of the first sub-model based on the ground truth coordinate value and the predicted coordinate value;

The training method for the second sub-model comprises:
step S204, in response to the completion of the training of the first sub-model, obtaining a second sample image comprising second items to be counted and labeling a ground truth threshold for binarizing the second sample image, wherein the outline of the second items to be counted in the second sample image, after being binarized based on the ground truth threshold, satisfies a clarity criterion;
step S205, inputting the second sample image into the first sub-model and obtaining a second output of the first sub-model, wherein the second output represents a predicted coordinate value of the region of interest of the second sample image;
step S206, inputting the second output into the second sub-model, and obtaining a predicted threshold for binarizing the second sample image output by the second sub-model;
step S207, calculating a loss value based on the ground truth threshold and the predicted threshold; and
step S208, adjusting parameters of the second sub-model based on the loss value, wherein the second sample image, after being binarized based on the predicted threshold, can be used to identify and count the second items to be counted included therein.

The training method 200 for the neural network model for image processing includes two phases, first training the first sub-model in the first phase to predict the region of interest in the image. It is to be understood that the first items to be counted may be located in a part of the first sample image, and thus predicting the region of interest containing the first items to be counted in the image enabling the subsequent computation process to focus on the region in which the items may be present, instead of processing the entire image, which facilitates the reduction of the amount of computation and accordingly improves the efficiency of subsequent item counting based on the processed image. In addition, the prediction of the region of interest facilitates to exclude background and interference factors unrelated to the items to be counted in the image, thereby reducing the possibility of mis-identification and mis-counting.

The first sub-model of the neural network model is obtained by training to predict the region of interest in the image. The first sub-model can be trained using multiple sample images in multiple image scenarios, which enables the first sub-model to have better generalization ability and to adapt to different backgrounds and item arrangements, thus achieving accurate identification of the region of interest in a variety of practical applications, providing a reliable basis for the subsequent image processing steps (such as binarization, item counting based on the processed image, etc.), ensuring these steps can be performed in the appropriate region, and thereby improving the overall performance of the entire item counting.

In the second stage of the model training, the second sub-model is trained in conjunction with the predicted coordinate value of the region of interest output by the first sub-model, which enables the second sub-model to focus on the processing of the region of interest without having to search in the whole image, which significantly reduces the computational complexity and resource consumption and improves the training efficiency. In addition, the second sub-model can learn and predict the optimal threshold for binarization by training a large number of labeled sample images.

This method is based on the ground truth threshold of training data, such that the model can automatically adjust the threshold to adapt to the change in outline, brightness and contrast of different kinds of items to be counted in different images, so that the model can still generate clear and accurate binarized images when facing different images and item arrangements, and thus providing high-quality input for subsequent item recognition and counting.

As a result, the neural network model that includes the first sub-model and the second sub-model is obtained by training using the training method 200 for the neural network model for image processing, the first sub-model and the second sub-model are used for predicting the region of interest in the image and for predicting the threshold for binarizing that image, respectively. By using the neural network model, the region of interest can be dynamically adjusted and accurately determined based on the actual image. The neural network model makes the boundary of the items in the binarized image clearer by dynamically adjusting the binarization threshold, especially in complex scenarios, such as in the cases that the items are stacked, there is large variation in illumination, or there is a complex background, and the model can automatically generate the optimal threshold for each particular image. This dynamic adjustment avoids errors that may be generated by the method using a fixed threshold, thus ensuring that the binarized image can accurately reflect the boundary between the items and the background, such that the result of the binarization of the image is more clear and more accurate.

In specific applications, the predicted threshold generated by the model can significantly improve the quality of binarized image, thus directly affecting the accuracy of item counting. Clear item outline enables subsequent identification counting method to identify the boundary of items more accurately, and thus avoiding the phenomenon of miscounting caused by blurred or incomplete boundary. In this way, the model ensures that the outline of the items can be clearly segmented in a variety of scenarios, thereby improving the overall accuracy of counting.

In addition, the second sub-model can perform binarization threshold learning on various sample images during the training, to have the ability to provide stable outputs for different types of images and item arrangements. This adaptive binarization processing approach significantly improves the generalization ability of the model, such that it can still output high-quality binarization results and ensure the accuracy of counting when facing different image conditions.

According to some embodiments, the region of interest is the smallest rectangular region of the image that can contain the items to be counted in the image. As a result, the interference of redundant background in the image is reduced and the accuracy of item counting based on the image is improved.

According to some embodiments, the first sub-model comprises a feature extraction network for extracting feature maps for the input image.

According to some embodiments, the step S206 comprises: obtaining feature maps extracted by the feature extraction network of the first sub-model for the second sample image; inputting the second output and the feature maps into the second sub-model, and obtaining the predicted threshold for binarizing the second sample image output by the second sub-model.

As a result, the second sub-model is trained using the feature maps extracted by the feature extraction network of the first sub-model and in conjunction with the predicted coordinate value of the region of interest output by the first sub-model.

According to some embodiments, the feature maps extracted by the feature extraction network of the first sub-model for the input image include a plurality of feature maps having different scales.

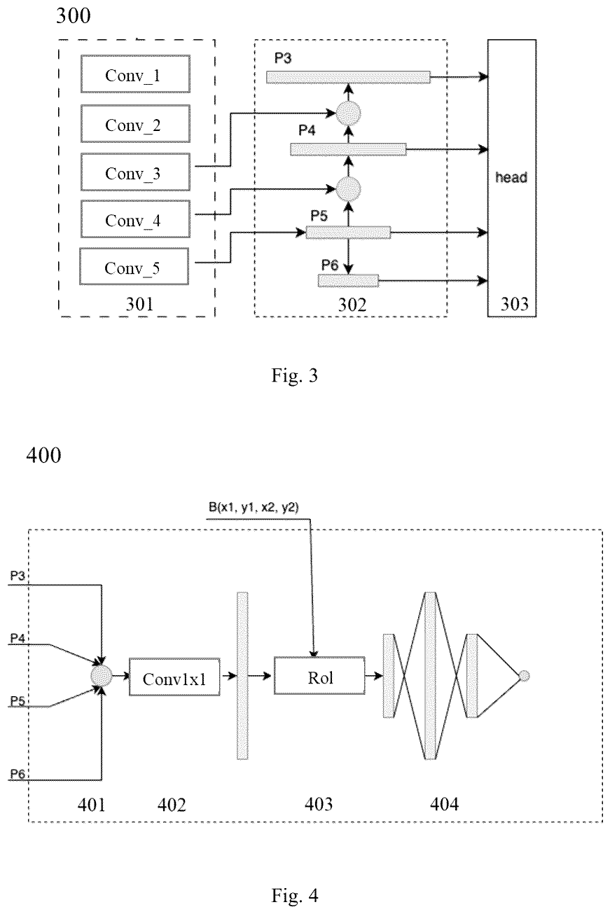

FIG. 3 illustrates an architectural diagram of a first sub-model according to embodiments of the present disclosure. As shown in FIG. 3, the first sub-model 300 comprises: a backbone network 301 consisting of a plurality of convolutional modules for receiving an input image; a feature extraction network 302 for extracting feature maps having different scales for the input image, wherein the feature maps of different scales are concatenated along a channel; and a detection head 303 for outputting an output of the model.

Exemplarily, the feature maps of different scales may include feature maps P3 of ⅛ size of the original image, feature maps P4 of 1/16 size of the original image, feature maps P5 of 1/32 size of the original image, and feature maps P6 of 1/64 size of the original image.

As a result, the feature maps using different scales can capture different levels of information of the image. The feature maps with larger scales (e.g., P3) retain more spatial detail information and are suitable for detecting larger objects or structures within a larger area; while the feature maps with smaller scales (e.g., P6) focus on features that are more abstract and global to facilitate to identify the overall outline and background of the objects. Such combination of multi-scale feature maps enables the model to consider both local details and global context, thereby enhancing the perceptual capability of the model. In addition, by combining the multi-scale feature maps, the model can better cope with items of various scales and different image resolutions. Regardless of whether the item is large or small, near or far in the image, the combination of multi-scale feature maps ensures the stability of the model in different scenarios and reduces the identification and counting errors caused by the change of item size. At the same time, it enables the model to effectively deal with complex scenarios and improves the generalization ability of handling diverse images.

In some examples, the network described above may be compressed, for example, by reducing the number of channels of the feature maps in each stage of the network, reducing the number of base modules stacked in each stage of the network, etc., to improve the inference speed of the first sub-model.

According to some embodiments, the parameters of the first sub-model are fixed during the training of the second sub-model. The backbone network 301 and the feature extraction network 302 of the first sub-model can be reused during the training of the second sub-model, and the parameters therein are frozen and do not participate in updating, so that only the parameters of the second sub-model are updated during the training. Thereby, the second sub-model is enabled to focus more on the accuracy of threshold prediction to improve the effect of binarization processing.

On the basis of the training method for the first sub-model, the training method 200 for the neural network model for image processing further comprises the training method for the second sub-model for predicting the threshold for binarizing the image.

FIG. 4 illustrates an architectural diagram of a second sub-model according to embodiments of the present disclosure. As shown in FIG. 4, the second sub-model 400 includes a scaling layer 401, a feature fusion layer 402, a pooling layer 403, and a fully connected layer 404. The step S207 comprises: inputting a plurality of feature maps (P3, P4, P5, P6) having different scales to the scaling layer 401 and obtaining feature maps having the same scale output by the scaling layer 401; inputting the feature maps having the same scale to the feature fusion layer 402 to channel concatenate the feature maps having the same scale and obtain a fusion feature map output by the feature fusion layer 402; inputting the fusion feature map and the second output to the pooling layer 403 to map the predicted coordinate value of the smallest rectangular region in the second sample image that can contain the items to be counted to the fusion feature map, and obtaining a pooled feature map output by the pooling layer 403; inputting the pooled feature map to the fully connected layer 404 and obtaining a predicted threshold output by the fully connected layer 404.

The input of the second sub-model is the feature maps (P3, P4, P5, P6) of each scale in the feature extraction network 302 of the second sub-model. Exemplarily, the scaling layer 401 of the second sub-model first scales the respective feature maps to 1/16 size of the original image, that is, the size of the feature map P4. Then, the features are concatenated along a channel dimension by the feature fusion layer 402, and the feature maps having the same scale ensure that the features are aligned at the pixel position corresponding to each channel, which ensures that the concatenated feature maps remain spatial consistence to facilitate subsequent convolution or pooling operations. By adjusting the scales of the feature maps to make them consistent, it can be ensured that the spatial information in the feature maps retains its integrity and accuracy after concatenation. And the features are fused with a convolution kernel having size of 1×1 and the channel is scaled to be 412 to obtain the fusion feature map. This process can be represented by the following equation:

$${F}_{i} = {f}_{s} ( {P}_{i} ) , 3 \leq i \leq 6$$

$$F = {Conv}_{1 \times 1} ( {F}_{3} ‖ {F}_{4} ‖ {F}_{5} ‖ {F}_{6} )$$

where fₛ(·) represents scaling operation, represents convolution operation and ∥ represents concatenation along the channel.

Exemplarily, the second output of the first sub-model represents the predicted coordinate value of the region of interest of the second sample image, which can be denoted as B(x₁, y₁, x₂, y₂). The pooling layer 403 can map the predicted coordinate value of the region of interest of the second sample image to the fusion feature map and can perform pooling to resize the region of interest into a size of S×S to output the pooled feature map F_{b}. The F_{b} is flattened and fed into the fully connected layer 404, and the predicted threshold is finally output by the fully connected layer 404. The process can be represented by the following equation:

$${F}_{b} = {G}_{b} ( F )$$

$${P}_{out} = {G}_{f} ( {F}_{b} )$$

where represents the operation of feature cropping and pooling and is the fully connected layer.

The hierarchical structure design as shown in FIG. 4 (the scaling layer, the feature fusion layer, the pooling layer and the fully connected layer) can utilize the multi-scale features of the image more effectively, the size differences between feature maps of different scales can be eliminated by inputting the feature maps of different scales (P3, P4, P5, P6) into the scaling layer 401 and scaling them to the same scale, such that the subsequent feature fusion operation is more consistent. This operation ensures that the features learned by the model on the feature maps of different scales can be effectively compared and combined at the same scale, thereby improving the accuracy of threshold prediction. Accurate positioning of the items to be counted is achieved by mapping the predicted coordinate value of the region of interest to the fusion feature map by the pooling layer 403 and pooling the region of interest into the fixed-size feature map.

As a result, the combination of scaling, feature fusion, pooling and fully connected layers enables the second sub-model to handle not only image features with single scale but also feature maps from multiple different scales. Such multi-scale fusion mechanism enables the model to maintain good generalization ability when facing various image resolutions and item sizes, to improve the accuracy of threshold prediction, and to ensure the robustness of binarization processing in complex image scenarios. In turn, the accuracy of subsequent item counting which is based on the processed image can be improved.

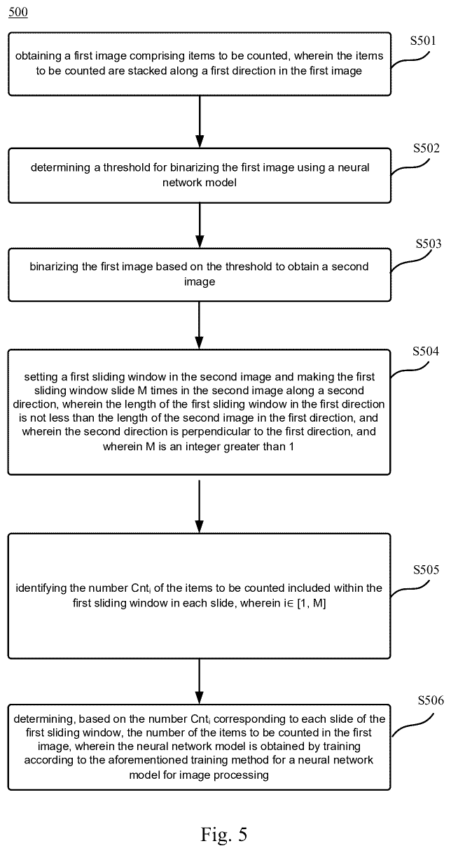

According to another aspect of the present disclosure, there is provided a method for image recognition. As shown in FIG. 5, the method 500 for image recognition comprises:
step S501, obtaining a first image comprising items to be counted, wherein the items to be counted are stacked along a first direction in the first image;
step S502, determining a threshold for binarizing the first image using a neural network model;
step S503, binarizing the first image based on the threshold to obtain a second image;
step S504, setting a first sliding window in the second image and making the first sliding window slide M times in the second image along a second direction, wherein the length of the first sliding window in the first direction is not less than the length of the second image in the first direction, and wherein the second direction is perpendicular to the first direction, and wherein M is an integer greater than 1;
step S505, identifying the number Cntᵢ of the items to be counted included within the first sliding window in each slide, wherein i∈[1, M]; and
step S506, determining, based on the number Cntᵢ corresponding to each slide of the first sliding window, the number of the items to be counted in the first image, wherein the neural network model is obtained by training according to the aforementioned training method for a neural network model for image processing.

According to some embodiments, the step S501 comprises: photographing the items to be counted to obtain an original image; determining a corresponding region of the items to be counted in the original image, and cropping the region as the first image.

Thereby, by determining the particular region where the items to be counted are located and cropping it as the second image, the interference of irrelevant backgrounds is reduced and the accuracy of subsequent image processing is improved.

Exemplarily, in the first image, the items to be counted are stacked along the first direction. Exemplarily, the first direction is a vertical direction and the second direction is a horizontal direction.

In the step S502, the threshold for binarizing the first image is determined by using the neural network model, and the binarization threshold can be adaptively determined to obtain the optimal binarization effect, and the error of manually setting the threshold can be reduced. Therefore, the flexibility and adaptability of the image binarization process are ensured, such that the binarization result can better adapt to different image scenarios, and the accuracy of subsequent item counting is improved.

In the step S503, the items to be counted in the image are separated from the background by binarization processing, such that the items in the image are more prominent and the effectiveness of image analysis is improved, thereby facilitating subsequent item counting.

In steps S504-Step S506, slide counting can be performed by setting a sliding window and sliding it in the image along the direction perpendicular to the direction in which the items are placed, the number of items can be counted at different locations to prevent the adhesion of the items at some locations from affecting the accuracy of counting, and the local counting errors can be effectively reduced. The comprehensiveness and accuracy of counting is ensured by accumulated counting through multiple sliding.

According to some embodiments, the region is the smallest rectangular region in the original image that can contain the items to be counted. As a result, the interference of redundant background of the image is reduced and the accuracy of item counting based on the image is improved.

According to some embodiments, determining the region corresponding to the items to be counted in the original image comprises: inputting the original image into the neural network model and obtaining a coordinate value of the region output by the neural network model. As a result, the coordinate value of the region of interest in the image is directly obtained by using the neural network model, so that the accuracy of region positioning can be improved, the error of manual labeling is avoided, and the automation degree of the counting scheme is further improved.

As a result, the neural network model is used to determine the region of interest and the threshold for binarizing the image, the region of interest and the threshold can be dynamically adjusted and determined according to the actual image, and the binarization of the image based on the dynamically predicted threshold enables the improvement of the accuracy of item counting when subsequently counting the items in the above processed image.

According to some embodiments, before the binarization of the first image, the method 500 for image recognition further comprises: converting the first image into a grayscale image and performing median filtering on the grayscale image. The color information can be removed and the image content can be simplified by converting the first image into a grayscale image, thereby reducing the computational complexity. In addition, the grayscale image retains the necessary brightness information, which facilitates the subsequent binarization process. The noise and isolated points in the image can be effectively removed by performing median filtering on the grayscale image, further improving the smoothness of the image. This process reduces the influence of the noise on the binarization result, which ensures more accurate threshold determination, and facilitates to improve the accuracy of item counting.

According to some embodiments, before setting the sliding window in the second image, the method 500 for image recognition further comprises: performing median filtering on the second image and performing a morphological erosion operation. After binarization, performing median filtering on the second image facilitates to further smooth the binarized image and to reduce small noise points that may be introduced during the binarization process, thus ensuring the continuity and integrity of the outline. The morphological erosion operation is used to remove minor interference and poorly connected pixels in the image to further optimize the outline shape of the items, such that the identification of the number of items in the sliding window is more accurate. The erosion operation can also effectively reduce misconnection phenomenon between items, ensure the independence of each item, and improve the accuracy of counting.

These pre-processing steps effectively improve the stability and robustness of the image recognition method, and ensure that an accurate item counting result can be obtained in complex and noisy scenarios. By noise reduction, smoothing and morphological processing, the influence of noise and adverse pixels on counting is reduced, and the accuracy of the subsequent sliding window counting is greatly improved, such that the whole image recognition method is more robust and reliable.

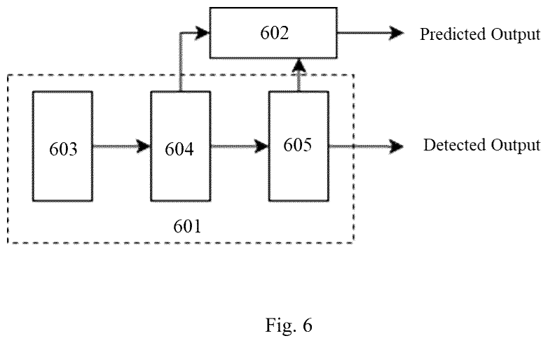

FIG. 6 illustrates a schematic diagram of image processing utilizing a neural network model according to embodiments of the present disclosure. As shown in FIG. 6, the neural network model includes a first sub-model 601 and a second sub-model 602. The first sub-model 601 includes a backbone network 603, a feature extraction network 604, and a detection head 605 for outputting a coordinate value of the smallest rectangular region containing items to be counted. The second sub-model 602 reuses the feature extraction network of the first sub-model to predict and output a threshold for binarization based on the coordinate value output by the first sub-model 601.

According to some embodiments, the step S504 comprises: making the first sliding window slide M times in the second image along a second direction with a first step length to slide from a first edge of the second image to a second edge of the second image.

By setting the first sliding window in the second image and making it slide along the second direction from the first edge of the second image to the second edge of the second image, it is ensured that all the features of the items to be counted are captured at different locations. By ensuring that the length of the sliding window in the first direction is not less than the length of the image, the entire image can be covered in the first direction, thereby ensuring that no item to be counted is missed. This setting facilitates to improve the comprehensiveness and accuracy of counting and avoid errors caused by uneven distribution of the items in the image.

According to some embodiments, the method 500 for image recognition further comprises: setting a second sliding window in the second image, wherein the length of the second sliding window in the first direction is not less than the length of the first sliding window in the first direction; before making the first sliding window start slide, making the second sliding window slide N times in the first sliding window along the second direction with a second step length, wherein N is an integer greater than 1; and after each of the M slides in the first sliding window, making the second sliding window slide N times in the first sliding window along the second direction with the second step length.

According to some embodiments, making the second sliding window slide N times in the first sliding window along the second direction with the second step length comprises: making the second sliding window slide N times in the first sliding window along the second direction with the second step length to slide from the first edge of the first sliding window to the second edge of the first sliding window.

As a result, the fineness of counting is further improved by setting the second sliding window within the first sliding window for refinement sliding. The operation of the second sliding window facilitates to capture minor local variations and details to avoid missing smaller items in complex scenarios or counting errors. Such combined use of multiple layers of sliding windows can significantly improve the accuracy and robustness of item counting in an image.

According to some embodiments, the step S505 comprises: during the slide of the second sliding window from the first edge of the first sliding window to the second edge of the first sliding window, determining the number Cntᵢ of the items to be counted contained in the second sliding window of each slide of the second sliding window, wherein j∈[1, N]; and determining, based on the number Cntⱼ corresponding to each slide of the second sliding window, the number Cntᵢ of the items to be counted contained in the first sliding window.

According to some embodiments, the determining, based on the number Cntⱼ corresponding to each slide of the second sliding window, the number Cntᵢ of the items to be counted contained in the first sliding window comprises: during the slide of the second sliding window from the first edge of the first sliding window to the second edge of the first sliding window, determining, based on the mode of the numbers Cntⱼ corresponding to each slide of the second sliding window, the number Cntᵢ of the items to be counted contained in the first sliding window.

During the slide of the second sliding window, determining the number of local items based on the mode of each slide can effectively reduce miscounting caused by noise or irregular shape in the image. As a statistical method, the mode can provide a stable counting method to avoid the influence of extreme values on the result, thereby improving the stability and reliability of counting.

According to some embodiments, the step S506 comprises: during the slide of the first sliding window from the first edge of the second image to the second edge of the second image, determining the number of the items to be counted in the first image based on the maximum value of the numbers Cntᵢ corresponding to each slide of the first sliding window.

During the slide of the first sliding window, determining the number of items in the entire image based on the maximum value of each slide can ensure that the final result has fully taken into account the items existing in overlapping or dense areas, thereby reducing omissions to the maximum extent and improving the accuracy of the counting result.

As a result, the method 500 for image recognition further refines the counting process by introducing the method of sliding window counting, such that the counting result is more accurate, and at the same time the possible omissions during the counting are reduced and the stability and accuracy of item counting is improved.

According to another aspect of the present disclosure, there is provided a training apparatus for a neural network model for image processing, wherein the neural network model comprises a first sub-model and a second sub-model, the first sub-model is used to predict a region of interest in an image, and the second sub-model is used to predict a threshold for binarizing the image.

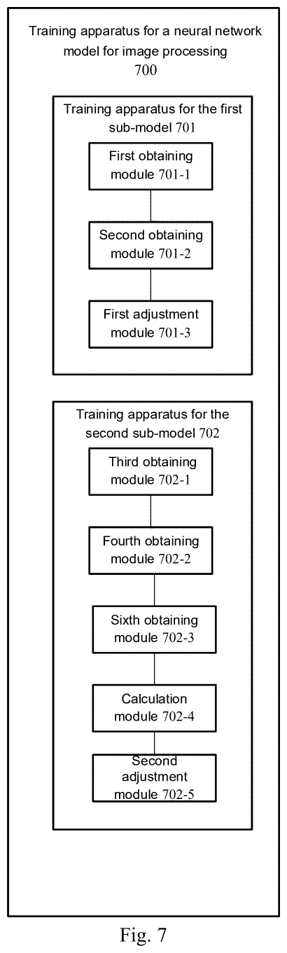

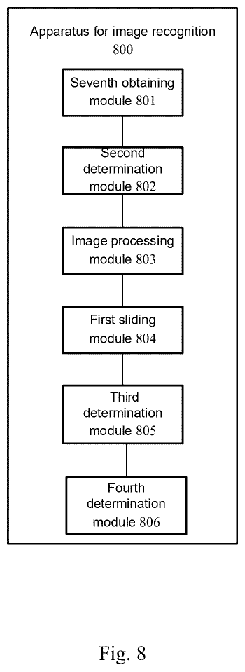

As shown in FIG. 7, the training apparatus 700 for the neural network model for image processing includes a training apparatus 701 for the first sub-model and a training apparatus 702 for the second sub-model.

The training apparatus for the first sub-model comprises: a first obtaining module 701-1 configured to obtain a first sample image comprising first items to be counted and label a ground truth coordinate value of a region of interest in the first sample image; a second obtaining module 701-2 configured to input the first sample image into the first sub-model to obtain a first output of the first sub-model, wherein the first output represents a predicted coordinate value of the region of interest in the first sample image; a first adjustment module 701-3 configured to adjust parameters of the first sub-model based on the ground truth coordinate value and the predicted coordinate value.

The training apparatus 702 for the second sub-model comprises: a third obtaining module 702-1 configured to, in response to the completion of the training of the first sub-model, obtain a second sample image comprising second items to be counted and label a ground truth threshold for binarizing the second sample image, wherein the outline of the second items to be counted in the second sample image, after being binarized based on the ground truth threshold, satisfies a clarity criterion; a fourth obtaining module 702-2 configured to input the second sample image into the first sub-model to obtain a second output of the first sub-model, wherein the second output represents a predicted coordinate value of the region of interest of the second sample image; a sixth obtaining module 702-4 configured to input the second output into the second sub-model to obtain a prediction threshold for binarizing the second sample image output by the second sub-model; a calculation module configured to calculate a loss value based on the ground truth threshold and the prediction threshold; and a second adjustment module 702-6 configured to adjust parameters of the second sub-model based on the loss value, wherein the second sample image, after being binarized based on the predicted threshold, can be used to identify and count the second items to be counted included therein.

The training apparatus 700 for the neural network model for image processing includes the training apparatus 701 for the first sub-model and the training apparatus 702 for the second sub-model. It is to be understood that the first items to be counted may be located in a part of the first sample image, and thus the first sub-model is trained by the training apparatus 701 for the first sub-model to predict the region of interest containing the first items to be counted in the image, which enables the subsequent computation process to focus on the region in which the items may be present, instead of processing the entire image, which facilitates to reduce the amount of computation and accordingly improves the efficiency of subsequent item counting based on the processed image. In addition, the prediction of the region of interest facilitates to exclude background and interference factors unrelated to the items to be counted in the image, thereby reducing the possibility of mis-identification and mis-counting.

The first sub-model of the neural network model is trained by the training apparatus 701 for the first sub-model to predict the region of interest in the image. The first sub-model can be trained using multiple sample images in multiple image scenarios, which enables the first sub-model to have better generalization ability and to adapt to different backgrounds and item arrangements, thus achieving accurate identification of the region of interest in a variety of practical applications, providing a reliable basis for the subsequent image processing steps (such as binarization, item counting based on the processed image, etc.), ensuring these steps can be performed in the appropriate region, and thereby improving the overall performance of the entire item counting.

The second sub-model is trained by the training apparatus 702 for the second sub-model in conjunction with the predicted coordinate value of the region of interest output by the first sub-model, which enables the second sub-model to focus on the processing of the region of interest without having to search in the whole image, which significantly reduces the computational complexity and resource consumption and improves the training efficiency. In addition, the second sub-model can learn and predict the optimal threshold for binarization by training a large number of labeled sample images. This method is based on the ground truth threshold of training data, such that the model can automatically adjust the threshold to adapt to the change in outline, brightness and contrast of different kinds of items to be counted in different images, so that the model can still generate clear and accurate binarized images when facing different images and item arrangements, and thus providing high-quality input for subsequent item recognition and counting.

As a result, the neural network model that includes the first sub-model and the second sub-model is obtained by training using the training apparatus 700 for the neural network model for image processing, and the first sub-model and the second sub-model are used for predicting the region of interest in the image and for predicting the threshold for binarizing that image, respectively. By using the neural network model, the region of interest can be dynamically adjusted and accurately determined based on the actual image. The neural network model makes the boundary of the items in the binarized image clearer by dynamically adjusting the binarization threshold, especially in complex scenarios, such as in the cases that the items are stacked, there is large variation in illumination, or there is a complex background, and the model can automatically generate the optimal threshold for each particular image. This dynamic adjustment avoids errors that may be generated by the method using a fixed threshold, thus ensuring that the binarized image can accurately reflect the boundary between the items and the background, such that the result of the binarization of the image is more clear and more accurate.

In specific applications, the predicted threshold generated by the model can significantly improve the quality of binarized image, thus directly affecting the accuracy of item counting. Clear item outline enables subsequent identification counting method to identify the boundary of items more accurately, and thus avoiding the phenomenon of miscounting caused by blurred or incomplete boundary. In this way, the model ensures that the outline of the items can be clearly segmented in a variety of scenarios, thereby improving the overall accuracy of counting.

In addition, the second sub-model can perform binarization threshold learning on various sample images during the training, to have the ability to provide stable outputs for different types of images and item arrangements. This adaptive binarization processing approach significantly improves the generalization ability of the model, such that it can still output high-quality binarization results and ensure the accuracy of counting when facing different image conditions.

According to some embodiments, the first sub-model comprises a feature extraction network for extracting feature maps for the input image.

According to some embodiments, the sixth obtaining module comprises: a fifth obtaining unit configured to obtain feature maps extracted by the feature extraction network of the first sub-model for the second sample image; a sixth obtaining unit configured to input the second output and the feature maps into the second sub-model and obtain the predicted threshold for binarizing the second sample image output by the second sub-model.

As a result, the second sub-model is trained using the feature maps extracted by the feature extraction network of the first sub-model and in conjunction with the predicted coordinate value of the region of interest output by the first sub-model.

According to some embodiments, the feature maps extracted by the feature extraction network of the first sub-model for the input image include a plurality of feature maps having different scales.

As a result, the feature maps using different scales can capture different levels of information of the image. The feature maps with larger scales (e.g., P3) retain more spatial detail information and are suitable for detecting larger objects or structures within a larger area; while the feature maps with smaller scales (e.g., P6) focus on features that are more abstract and global to facilitate to identify the overall outline and background of the objects. Such combination of multi-scale feature maps enables the model to consider both local details and global context, thereby enhancing the perceptual capability of the model. In addition, by combining the multi-scale feature maps, the model can better cope with items of various scales and different image resolutions. Regardless of whether the item is large or small, near or far in the image, the combination of multi-scale feature maps ensures the stability of the model in different scenarios and reduces the identification and counting errors caused by the change of item size. At the same time, it enables the model to effectively deal with complex scenarios and improves the generalization ability of handling diverse images.

According to some embodiments, the parameters of the first sub-model are fixed during the training of the second sub-model.

According to some embodiments, the second sub-model includes a scaling layer, a feature fusion layer, a pooling layer, and a fully connected layer, and wherein the sixth obtaining module comprises: a first obtaining unit configured to input the plurality of feature maps having different scales to the scaling layer and obtain feature maps having the same scale output by the scaling layer; a second obtaining unit configured to input the feature maps having the same scale to the feature fusion layer to channel concatenate the feature maps having the same scale and obtain a fusion feature map output by the feature fusion layer; a third obtaining unit configured to input the fusion feature map and the second output to the pooling layer to map the predicted coordinate value of the smallest rectangular region in the second sample image that can contain the items to be counted to the fusion feature map, and obtain a pooled feature map output by the pooling layer; a fourth obtaining unit configured to input the pooled feature map to the fully connected layer and obtain the predicted threshold output by the fully connected layer.

The hierarchical structure design (the scaling layer, the feature fusion layer, the pooling layer and the fully connected layer) can utilize the multi-scale features of the image more effectively, the first obtaining unit can eliminate the size differences between feature maps of different scales by inputting the feature maps of different scales into the scaling layer and scaling them to the same scale, such that the subsequent feature fusion operation is more consistent. This operation ensures that the features learned by the model on the feature maps of different scales can be effectively compared and combined at the same scale, thereby improving the accuracy of threshold prediction. The third obtaining unit enables accurate positioning of the items to be counted by mapping the predicted coordinate value of the region of interest to the fusion feature map by the pooling layer and pooling the region of interest into the fixed-size feature map.

As a result, the combination of scaling, feature fusion, pooling and fully connected layers enables the second sub-model to handle not only image features with single scale but also feature maps from multiple different scales. Such multi-scale fusion mechanism enables the model to maintain good generalization ability when facing various image resolutions and item sizes, to improve the accuracy of threshold prediction, and to ensure the robustness of binarization processing in complex image scenarios. In turn, the accuracy of subsequent item counting which is based on the processed image can be improved.

According to another aspect of the present disclosure, there is provided an apparatus for image recognition. As shown in FIG. 8, the apparatus 800 for image recognition comprises: a seventh obtaining module 801 configured to obtain a first image comprising items to be counted, wherein the items to be counted in the first image are stacked along a first direction; a second determination module 802 configured to determine a threshold for binarizing the first image using a neural network model; an image processing module 803 configured to binarize the first image based on the threshold to obtain a second image; a first sliding module 804 configured to set a first sliding window in the second image and make the first sliding window slide M times in the second image along a second direction, wherein the length of the first sliding window in the first direction is not less than the length of the second image in the first direction, and wherein the second direction is perpendicular to the first direction, and wherein M is an integer greater than 1; a third determination module 805 configured to identify the number Cntᵢ of the items to be counted included within the first sliding window in each slide, wherein i∈[1, M]; and a fourth determination module 806 configured to determine, based on the number Cntᵢ corresponding to each slide of the first sliding window, the number of the items to be counted in the first image, wherein the neural network model is obtained by training according to the aforementioned training method for a neural network model for image processing.

According to some embodiments, the seventh obtaining module comprises: a photograph unit configured to photograph the items to be counted to obtain an original image; a crop unit configured to determine a corresponding region of the items to be counted in the original image, and crop the region as the first image.

Thereby, by determining the particular region where the items to be counted are located and cropipng it as the second image, the interference of irrelevant backgrounds is reduced and the accuracy of subsequent image processing is improved.

Exemplarily, in the first image, the items to be counted are stacked along the first direction. Exemplarily, the first direction is a vertical direction and the second direction is a horizontal direction.

The second determination module 802 determines the threshold for binarizing the first image using the neural network model, the module can adaptively determine the binarization threshold to obtain the optimal binarization effect, and the error of manually setting the threshold is reduced. Therefore, the flexibility and adaptability of the image binarization process are ensured, such that the binarization result can better adapt to different image scenarios, and the accuracy of subsequent item counting is improved.

The image processing module 803 separates the items to be counted in the image from the background by binarization processing, such that the items in the image are more prominent and the effectiveness of image analysis is improved, thereby facilitating subsequent item counting.

The first sliding module 804 performs slide counting by setting a sliding window and sliding it in the image along the direction perpendicular to the direction in which the items are placed, which enables the third determination module 805 and the fourth determination module 806 to count the number of items at different locations to prevent the adhesion of the items at some locations from affecting the accuracy of counting, thereby effectively reducing the local counting errors. The comprehensiveness and accuracy of counting is ensured by accumulated counting through multiple sliding.

According to some embodiments, the region is the smallest rectangular region in the first image that can contain the items to be counted. As a result, the interference of redundant background of the image is reduced and the accuracy of item counting based on the image is improved.

According to some embodiments, the crop unit is further configured to: input the original image into the neural network model and obtain a coordinate value of the region output by the neural network model. As a result, the crop unit directly obtains the coordinate value of the region of interest in the image by using the neural network model, so that the accuracy of region positioning can be improved, the error of manual labeling is avoided, and the automation degree of the counting scheme is further improved.

As a result, the neural network model is used to determine the region of interest and the threshold for binarizing the image, the region of interest and the threshold can be dynamically adjusted and determined according to the actual image, and the binarization of the image based on the dynamically predicted threshold enables the improvement of the accuracy of item counting when subsequently counting the items in the above processed image.

According to some embodiments, the first sliding module 804 is configured to: make the first sliding window slide M times in the second image along a second direction with a first step length to slide from a first edge of the second image to a second edge of the second image.

The first sliding module 804 sets the first sliding window in the second image and makes it slide along the second direction from the first edge of the second image to the second edge of the second image to ensure all the features of the items to be counted are captured at different locations. By ensuring that the length of the sliding window in the first direction is not less than the length of the image, the entire image can be covered in the first direction, thereby ensuring that no item to be counted is missed. This setting facilitates to improve the comprehensiveness and accuracy of counting and avoid errors caused by uneven distribution of the items in the image.

According to some embodiments, the apparatus 800 for image recognition further comprises: a setting module configured to set a second sliding window in the second image, wherein the length of the second sliding window in the first direction is not less than the length of the first sliding window in the first direction; a second sliding module configured to, before making the first sliding window start to slide, make the second sliding window slide N times in the first sliding window along the second direction with a second step length, wherein N is an integer greater than 1; and a third sliding module configured to, after each of the M slides in the first sliding window, make the second sliding window slide N times in the first sliding window along the second direction with the second step length.

According to some embodiments, the second sliding module and the third sliding module are further configured to: make the second sliding window slide N times in the first sliding window along the second direction with the second step length to slide from the first edge of the first sliding window to the second edge of the first sliding window.

As a result, the fineness of counting is further improved by setting the second sliding window within the first sliding window for refinement sliding. The operation of the second sliding window facilitates to capture minor local variations and details to avoid missing smaller items in complex scenarios or counting errors. Such combined use of multiple layers of sliding windows can significantly improve the accuracy and robustness of item counting in an image.

According to some embodiments, the third determination module comprises: a first determination unit configured to, during the slide of the second sliding window from the first edge of the first sliding window to the second edge of the first sliding window, determine the number Cntⱼ of the items to be counted contained in the second sliding window of each slide of the second sliding window, wherein j∈[1, N]; and a second determination unit configured to determine, based on the number Cntⱼ corresponding to each slide of the second sliding window, the number Cntᵢ of the items to be counted contained in the first sliding window.

According to some embodiments, the second determination unit is further configured to: during the slide of the second sliding window from the first edge of the first sliding window to the second edge of the first sliding window, determine, based on the mode of the numbers Cnt corresponding to each slide of the second sliding window, the number Cntᵢ of the items to be counted contained in the first sliding window.

During the slide of the second sliding window, determining the number of local items based on the mode of each slide can effectively reduce miscounting caused by noise or irregular shape in the image. As a statistical method, the mode can provide a stable counting method to avoid the influence of extreme values on the result, thereby improving the stability and reliability of counting.

According to some embodiments, the fourth determination unit is further configured to: during the slide of the first sliding window from the first edge of the second image to the second edge of the second image, determine the number of the items to be counted in the first image based on the maximum value of the numbers Cntᵢ corresponding to each slide of the first sliding window.

During the slide of the first sliding window, determining the number of items in the entire image based on the maximum value of each slide can ensure that the final result has fully taken into account the items existing in overlapping or dense areas, thereby reducing omissions to the maximum extent and improving the accuracy of the counting result.

As a result, the apparatus 800 for image recognition further refines the counting process by introducing the method of sliding window counting, such that the counting result is more accurate, and at the same time the possible omissions during the counting is reduced and the stability and accuracy of item counting is improved.

According to another aspect of the present disclosure, there is provided an electronic device, comprising: at least one processor; and a memory communicatively connected to the at least one processor; wherein the memory stores instructions executable by the at least one processor, and the instructions are executed by the at least one processor to enable the at least one processor to perform any of the foregoing methods.

According to another aspect of the present disclosure, there is provided a non-transient computer-readable storage medium storing computer instructions, wherein the computer instructions are used to enable the computer to perform any of the foregoing methods.

According to another aspect of the present disclosure, there is provided a computer program product, including a computer program, wherein the computer program implements any of the foregoing methods when executed by a processor.

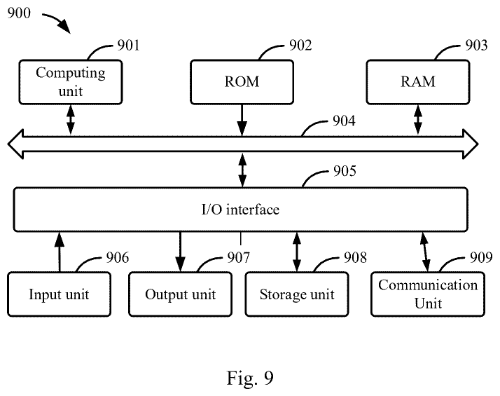

As shown in FIG. 9, the electronic device 900 includes a computing unit 901, which may perform various appropriate actions and processing according to a computer program stored in a read-only memory (ROM) 902 or a computer program loaded into a random access memory (RAM) 903 from a storage unit 908. In the RAM 903, various programs and data required by the operation of the electronic device 900 may also be stored. The computing unit 901, the ROM 902, and the RAM 903 are connected to each other through a bus 904. Input/output (I/O) interface 905 is also connected to the bus 904.

A plurality of components in the electronic device 900 are connected to a I/O interface 905, including: an input unit 906, an output unit 907, a storage unit 908, and a communication unit 909. The input unit 906 may be any type of device capable of inputting information to the electronic device 900, the input unit 906 may receive input digital or character information and generate a key signal input related to user setting and/or function control of the electronic device, and may include, but is not limited to, a mouse, a keyboard, a touch screen, a track pad, a trackball, a joystick, a microphone, and/or a remote control. The output unit 907 may be any type of device capable of presenting information, and may include, but are not limited to, a display, a speaker, a video/audio output terminal, a vibrator, and/or a printer. The storage unit 908 may include, but is not limited to, a magnetic disk and an optical disk. The communication unit 909 allows the electronic device 900 to exchange information/data with other devices over a computer network, such as the Internet, and/or various telecommunication networks, and may include, but is not limited to, a modem, a network card, an infrared communication device, a wireless communication transceiver and/or a chipset, such as a Bluetooth device, a 802.11 device, a WiFi device, a WIMAX device, a cellular communication device, and/or the like.

The computing unit 901 may be a variety of general and/or special purpose processing components with processing and computing capabilities. Some examples of the computing unit 901 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, etc. The computing unit 901 performs the various methods and processes described above, for example, the training method for the neural network model for image processing and the method for image recognition. For example, in some embodiments, the training method for the neural network model for image processing and the method for image recognition may be implemented as a computer software program tangibly contained in a machine-readable medium, such as the storage unit 908. In some embodiments, part or all of the computer program may be loaded and/or installed onto the electronic device 900 via the ROM 902 and/or the communication unit 909. When the computer program is loaded to the RAM 903 and executed by the computing unit 901, one or more steps of the training method for the neural network model for image processing and the method for image recognition described above may be performed. Alternatively, in other embodiments, the computing unit 901 may be configured to perform the training method for the neural network model for image processing and the method for image recognition by any other suitable means (e.g., with the aid of firmware).

Various embodiments of the systems and techniques described above herein may be implemented in a digital electronic circuit system, an integrated circuit system, a field programmable gate array (FPGA), an application specific integrated circuit (ASIC), a dedicated standard product (ASSP), a system of system on a chip system (SoC), a complex programmable logic device (CPLD), computer hardware, firmware, software, and/or combinations thereof. These various embodiments may include: implementation in one or more computer programs that may be executed and/or interpreted on a programmable system including at least one programmable processor, where the programmable processor may be a dedicated or universal programmable processor that may receive data and instructions from a storage system, at least one input device, and at least one output device, and transmit data and instructions to the storage system, the at least one input device, and the at least one output device.

The program code for implementing the method of the present disclosure may be written in any combination of one or more programming languages. These program code may be provided to a processor or controller of a general-purpose computer, a special purpose computer, or other programmable data processing device such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium, which may contain or store a program for use by or in conjunction with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of a machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

To provide interaction with a user, the systems and techniques described herein may be implemented on a computer having: a display device (e.g., a CRT (cathode ray tube) or an LCD (liquid crystal display) monitor) for displaying information to a user; and a keyboard and pointing device (e.g., a mouse or trackball) by which a user may provide input to the computer. Other types of devices may also be used to provide interaction with a user; for example, the feedback provided to the user may be any form of perception feedback (e.g., visual feedback, auditory feedback, or tactile feedback); and the input from the user may be received in any form, including acoustic input, voice input, or haptic input.

The systems and techniques described herein may be implemented in a computing system including a back-end component (e.g., as a data server), or a computing system including a middleware component (e.g., an application server), or a computing system including a front-end component (e.g., a user computer with a graphic user interface or a web browser, the user may interact with implementations of the systems and techniques described herein through the graphic user interface or the web browser), or in a computing system including any combination of such back-end components, middleware components, or front-end components. The components of the system may be interconnected by digital data communication (e.g., a communications network) in any form or medium. Examples of communication networks include a local area network (LAN), a wide area network (WAN), and the Internet.

The computer system may include a client and a server. Clients and servers are generally remote from each other and typically interact through a communication network. The relationship between clients and servers is generated by computer programs running on respective computers and having a client-server relationship to each other. The server may be a cloud server, or may be a server of a distributed system, or a server incorporating a block chain.

It should be understood that the various forms of processes shown above may be used, and the steps may be reordered, added, or deleted. For example, the steps described in the present disclosure may be performed in parallel or sequentially or in a different order, as long as the results expected by the technical solutions disclosed in the present disclosure can be achieved, and no limitation is made herein.

Although embodiments or examples of the present disclosure have been described with reference to the accompanying drawings, it should be understood that the foregoing methods, systems, and devices are merely embodiments or examples, and the scope of the present disclosure is not limited by these embodiments or examples, but is only defined by the authorized claims and their equivalents. Various elements in the embodiments or examples may be omitted or may be replaced by equivalent elements thereof. Further, the steps may be performed in an order different from that described in the present disclosure. Further, various elements in the embodiments or examples may be combined in various ways. Importantly, with the evolution of the technology, many elements described herein may be replaced by equivalent elements appearing after the present disclosure.

1. A training method for a neural network model for image processing, wherein the neural network model comprises a first sub-model and a second sub-model, and wherein the training method comprises a training method for the first sub-model and a training method for the second sub-model, and wherein the training method for the first sub-model comprises:
obtaining a first sample image comprising first items to be counted, and labeling a ground truth coordinate value of a region of interest in the first sample image;
inputting the first sample image into the first sub-model and obtaining a first output of the first sub-model, wherein the first output represents a predicted coordinate value of the region of interest in the first sample image;
adjusting parameters of the first sub-model based on the ground truth coordinate value and the predicted coordinate value, and
wherein the training method for the second sub-model comprises:
in response to the completion of the training of the first sub-model, obtaining a second sample image comprising second items to be counted and labeling a ground truth threshold for binarizing the second sample image, wherein the outline of the second items to be counted in the second sample image, after being binarized based on the ground truth threshold, satisfies a clarity criterion;
inputting the second sample image into the first sub-model and obtaining a second output of the first sub-model, wherein the second output represents a predicted coordinate value of the region of interest of the second sample image;
inputting the second output into the second sub-model and obtaining a predicted threshold for binarizing the second sample image output by the second sub-model;
calculating a loss value based on the ground truth threshold and the predicted threshold; and
adjusting parameters of the second sub-model based on the loss value,
wherein the second sample image, after being binarized based on the predicted threshold, can be used to identify and count the second items to be counted included therein.

2. The method according to claim 1, wherein the first sub-model comprises a feature extraction network for extracting feature maps for the input image, and wherein the inputting the second output into the second sub-model and obtaining a predicted threshold for binarizing the second sample image output by the second sub-model comprises:
obtaining feature maps extracted by the feature extraction network of the first sub-model for the second sample image;
inputting the second output and the feature maps into the second sub-model and;
obtaining the predicted threshold for binarizing the second sample image output by the second sub-model.

3. The method according to claim 2, wherein the feature maps extracted by the feature extraction network of the first sub-model for the input image comprise a plurality of feature maps having different scales.

4. The method according to claim 3, wherein the second sub-model includes a scaling layer, a feature fusion layer, a pooling layer, and a fully connected layer, and wherein the inputting the second output and the feature maps into the second sub-model and obtaining the predicted threshold for binarizing the second sample image output by the second sub-model comprises:
inputting the plurality of feature maps having different scales to the scaling layer and obtaining feature maps having the same scale output by the scaling layer;
inputting the feature maps having the same scale to the feature fusion layer to channel concatenate the feature maps having the same scale, and obtaining a fusion feature map output by the feature fusion layer;
inputting the fusion feature map and the second output to the pooling layer to map the predicted coordinate value of the smallest rectangular region in the second sample image that can contain the items to be counted to the fusion feature map, and obtaining a pooled feature map output by the pooling layer; and
inputting the pooled feature map to the fully connected layer and obtaining the predicted threshold output by the fully connected layer.

5. The method according to claim 1, wherein the region of interest is the smallest rectangular region of the image that can contain the items to be counted in the image.

6. The method according to claim 1, wherein the parameters of the first sub-model are fixed during the training of the second sub-model.

7. A method according to claim 1, further comprising:
obtaining a first image comprising items to be counted, wherein the items to be counted are stacked along a first direction in the first image;
determining a threshold for binarizing the first image using the trained neural network model;
binarizing the first image based on the threshold to obtain a second image;
setting a first sliding window in the second image and making the first sliding window slide M times in the second image along a second direction, wherein the length of the first sliding window in the first direction is not less than the length of the second image in the first direction, and wherein the second direction is perpendicular to the first direction, and wherein Mis an integer greater than 1;
identifying a number Cntᵢ of the items to be counted included within the first sliding window in each slide, wherein i∈[1, M]; and
determining, based on the number Cntᵢ corresponding to each slide of the first sliding window, a number of the items to be counted in the first image.

8. The method according to claim 7, further comprising:
setting a second sliding window in the second image, wherein the length of the second sliding window in the first direction is not less than the length of the first sliding window in the first direction;
before making the first sliding window start to slide, making the second sliding window slide N times within the first sliding window along the second direction with a second step length, wherein N is an integer greater than 1; and
after each of the M slides of the first sliding window, making the second sliding window slide N times within the first sliding window along the second direction with the second step length.

9. The method according to claim 8, wherein the making the second sliding window slide N times within the first sliding window along the second direction with a second step length comprises:
making the second sliding window slide N times within the first sliding window along the second direction with the second step length to slide from the first edge of the first sliding window to the second edge of the first sliding window, and
wherein the making the first sliding window slide M times in the second image along a second direction comprises:
making the first sliding window slide M times in the second image along the second direction with a first step length to slide from the first edge of the second image to the second edge of the second image.

10. The method according to claim 9, wherein the identifying a number Cntᵢ of the items to be counted included within the first sliding window in each slide comprises:
during the slide of the second sliding window from the first edge of the first sliding window to the second edge of the first sliding window,
determining a number Cntⱼ of the items to be counted contained in the second sliding window of each slide of the second sliding window, wherein j∈[1, N]; and
determining, based on the number Cntⱼ corresponding to each slide of the second sliding window, the number Cntᵢ of the items to be counted contained in the first sliding window.

11. The method according to claim 10, wherein the determining, based on the number Cntᵢ corresponding to each slide of the first sliding window, a number of the items to be counted in the first image comprises:
during the slide of the first sliding window from the first edge of the second image to the second edge of the second image, determining the number of the items to be counted in the first image based on the maximum value of the numbers Cntᵢ corresponding to each slide of the first sliding window.

12. The method according to claim 10, wherein the determining, based on the number Cntⱼ corresponding to each slide of the second sliding window, the number Cntᵢ of the items to be counted contained in the first sliding window comprises:
during the slide of the second sliding window from the first edge of the first sliding window to the second edge of the first sliding window, determining, based on the mode of the numbers Cntⱼ corresponding to each slide of the second sliding window, the number Cntᵢ of the items to be counted contained in the first sliding window.

13. The method according to claim 7, wherein the obtaining a first image comprising items to be counted comprises:
photographing the items to be counted to obtain an original image;
determining a corresponding region of the items to be counted in the original image; and
cropping the region as the first image.

14. The method according to claim 13, wherein the determining a corresponding region of the items to be counted in the original image comprises:
inputting the original image into the neural network model and obtaining a coordinate value of the region output by the neural network model.

15. The method according to claim 13, wherein the region is the smallest rectangular region in the original image that can contain the items to be counted.

16.-30. (canceled)

31. An electronic device, comprising:
at least one processor; and
a memory communicatively connected to the at least one processor; wherein
the memory stores instructions executable by the at least one processor, and the instructions are executed by the at least one processor to cause the at least one processor to operations comprising training operations for a neural network model for image processing, wherein the neural network model comprises a first sub-model and a second sub-model, and wherein the training operations for the neural network model comprises operations for training the first sub-model and operations for training the second sub-model, and wherein the operations for training the first sub-model comprise:
obtaining a first sample image comprising first items to be counted, and labeling a ground truth coordinate value of a region of interest in the first sample image;
inputting the first sample image into the first sub-model and obtaining a first output of the first sub-model, wherein the first output represents a predicted coordinate value of the region of interest in the first sample image;
adjusting parameters of the first sub-model based on the ground truth coordinate value and the predicted coordinate value, and
wherein the operations for training the second sub-model comprise:
in response to the completion of the training of the first sub-model, obtaining a second sample image comprising second items to be counted and labeling a ground truth threshold for binarizing the second sample image, wherein the outline of the second items to be counted in the second sample image, after being binarized based on the ground truth threshold, satisfies a clarity criterion;
inputting the second sample image into the first sub-model and obtaining a second output of the first sub-model, wherein the second output represents a predicted coordinate value of the region of interest of the second sample image;
inputting the second output into the second sub-model and obtaining a predicted threshold for binarizing the second sample image output by the second sub-model;
calculating a loss value based on the ground truth threshold and the predicted threshold; and
adjusting parameters of the second sub-model based on the loss value,
wherein the second sample image, after being binarized based on the predicted threshold, can be used to identify and count the second items to be counted included therein.

32. A non transient computer-readable storage medium storing computer instructions, wherein the computer instructions are used to cause the computer to perform operations comprising training operations for a neural network model for image processing, wherein the neural network model comprises a first sub-model and a second sub-model, and wherein the training operations for the neural network model comprises operations for training the first sub-model and operations for training the second sub-model, and wherein the operations for training the first sub-model comprise:
obtaining a first sample image comprising first items to be counted, and labeling a ground truth coordinate value of a region of interest in the first sample image;
inputting the first sample image into the first sub-model and obtaining a first output of the first sub-model, wherein the first output represents a predicted coordinate value of the region of interest in the first sample image;
adjusting parameters of the first sub-model based on the ground truth coordinate value and the predicted coordinate value, and
wherein the operations for training the second sub-model comprise:
in response to the completion of the training of the first sub-model, obtaining a second sample image comprising second items to be counted and labeling a ground truth threshold for binarizing the second sample image, wherein the outline of the second items to be counted in the second sample image, after being binarized based on the ground truth threshold, satisfies a clarity criterion;
inputting the second sample image into the first sub-model and obtaining a second output of the first sub-model, wherein the second output represents a predicted coordinate value of the region of interest of the second sample image;
inputting the second output into the second sub-model and obtaining a predicted threshold for binarizing the second sample image output by the second sub-model;
calculating a loss value based on the ground truth threshold and the predicted threshold; and
adjusting parameters of the second sub-model based on the loss value,
wherein the second sample image, after being binarized based on the predicted threshold, can be used to identify and count the second items to be counted included therein.

33. (canceled)

34. The electronic device according to claim 31, the operations further comprising:
obtaining a first image comprising items to be counted, wherein the items to be counted are stacked along a first direction in the first image;
determining a threshold for binarizing the first image using the trained neural network model;
binarizing the first image based on the threshold to obtain a second image;
setting a first sliding window in the second image and making the first sliding window slide M times in the second image along a second direction, wherein the length of the first sliding window in the first direction is not less than the length of the second image in the first direction, and wherein the second direction is perpendicular to the first direction, and wherein Mis an integer greater than 1;
identifying a number Cntᵢ of the items to be counted included within the first sliding window in each slide, wherein i∈[1, M]; and
determining, based on the number Cntᵢ corresponding to each slide of the first sliding window, a number of the items to be counted in the first image.

35. The non-transitory computer-readable storage medium storing computer instructions according to claim 32, the operations further comprising:
obtaining a first image comprising items to be counted, wherein the items to be counted are stacked along a first direction in the first image;
determining a threshold for binarizing the first image using the trained neural network model;
binarizing the first image based on the threshold to obtain a second image;
setting a first sliding window in the second image and making the first sliding window slide M times in the second image along a second direction, wherein the length of the first sliding window in the first direction is not less than the length of the second image in the first direction, and wherein the second direction is perpendicular to the first direction, and wherein M is an integer greater than 1;
identifying a number Cntᵢ of the items to be counted included within the first sliding window in each slide, wherein i∈[1, M]; and
determining, based on the number Cntᵢ corresponding to each slide of the first sliding window, a number of the items to be counted in the first image.

36. The non-transitory computer-readable storage medium storing computer instructions according to claim 35, the operations further comprising:
setting a second sliding window in the second image, wherein the length of the second sliding window in the first direction is not less than the length of the first sliding window in the first direction;
before making the first sliding window start to slide, making the second sliding window slide N times within the first sliding window along the second direction with a second step length, wherein N is an integer greater than 1; and
after each of the M slides of the first sliding window, making the second sliding window slide N times within the first sliding window along the second direction with the second step length.
